(19) United States
(12) Patent Application Publication
(10) Pub. No.: US 2025/0194849 A1
(43) Pub. Date: Jun. 19, 2025

(54) COFFEE MACHINE AND CORRESPONDING MANAGEMENT METHOD

(71) Applicant: DE' LONGHI APPLIANCES S.R.L. CON UNICO SOCIO, Treviso (IT)

(72) Inventors: Guido Quaratesi, Treviso (IT); Matilde Donzelli, Treviso (IT); Thomas Zanardo, Treviso (IT)

(73) Assignee: DE' LONGHI APPLIANCES S.R.L. CON UNICO SOCIO, Treviso (IT)

(21) Appl. No.: 18/846,204

(22) PCT Filed: Mar. 10, 2023
(86) PCT No.: PCT/IT2023/050071

§ 371 Date: Sep. 11, 2024

(30) Foreign Application Priority Data
Mar. 11, 2022 (IT) 102022000004751

(51) Int. Cl. A47J 31/52

(52) U.S. Cl. CPC A47J 31/521

(57) ABSTRACT

Coffee machine (10). comprising a control unit (11) provided with a processor (12) and connected to a user interface (13) provided with at least one display (14) for displaying beverages (B1, B2, B3 . . . Bn) that can be dispensed by means of the coffee machine (10).

### FIELD OF THE INVENTION

The present invention concerns a coffee machine and a corresponding management method, which allows in particular to facilitate and speed up the use of the machine by a user.

### BACKGROUND OF THE INVENTION

Modern coffee machines comprise a control unit provided with a processor and a user interface equipped with at least one information display and a series of keys, also of the touchscreen type, by means of which it is possible to choose the type of beverage to be prepared using the machine.

These modern coffee machines are able to produce a considerable number of beverages, for example espresso coffee, milk coffee or latte, American coffee, cappuccino or others, and it is also possible to vary some parameters of these beverages as desired, for example the quantity, the aroma or others.

The displays of these user interfaces are therefore normally equipped with a beverage selection menu and the desired parameters have to be set for each beverage.

Every time the user takes some time to select the desired beverage and the corresponding parameters, even if he/she usually tends to consume a specific beverage more frequently, both in absolute terms and also considering the different times of the day. It is possible, for example, that the same user may habitually consume a first beverage in the morning and may habitually consume a second beverage in the afternoon and so on. Thus, user habits can be similar from one day to the next. Consequently, known coffee machines tend to have certain beverage selection operations repeated several times in the space of a day, or day after day, making them prolonged and laborious to use.

The times required to select the desired beverage can also become a significant problem if the coffee machine is located for example in an office, where a plurality of different users have to select their own beverage.

Furthermore, the prolonged use of the coffee machine and the corresponding laboriousness in the operations of selecting a frequently desired beverage, entails an unwanted consumption of electric energy.

Document US2021/235921A1 describes a machine for preparing beverages, which provides to monitor a plurality of data during the preparation of a beverage and to store them in a server together with data correlated to a specific user and a possible evaluation of the beverage by the user, and to display graphically on a display the preferences expressed by a user regarding the organoleptic characteristics of a beverage in terms of taste, aroma and suchlike in determinate time intervals. In this way, a user can see if and how their taste preferences have changed over time.

Document US2014/166703A1 describes an apparatus for dispensing liquid condiments on the basis of information obtained from a cooking guide system connected to the Internet, so as to facilitate the preparation of certain recipes by a user.

There is therefore a need to perfect a coffee machine and a corresponding management method which can overcome at least one of the disadvantages of the state of the art.

In particular, one purpose of the present invention is to provide a coffee machine which is simpler and more intuitive to use.

Another purpose of the present invention is to provide a coffee machine by means of which the usually desired beverage can be selected more quickly than in known machines.

Another purpose of the present invention is to provide a coffee machine which limits the times of use and the laboriousness of the operations to be performed by a user to choose a beverage.

Another purpose is also to provide a machine which, thanks to the fact that it requires fewer selections and commands by a user, also allows to obtain energy savings.

Another purpose of the present invention is to perfect an effective and simple method for managing a coffee machine.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a coffee machine according to the present invention comprises a control unit provided with a processor and connected to a user interface provided with at least one display for displaying dispensable beverages.

According to a characteristic aspect of the invention, the control unit comprises at least one data storage module, configured to automatically store information regarding at least the beverages selected by a user by means of the user interface in a determinate time interval and a time stamp correlated to the moment in which such beverages are selected, and the control unit is configured to process a plurality of lists of selected beverages, respectively associated with predefined time ranges as a function of the time stamp, and to display the beverages associated with one of the lists on the display on the basis of the time interval and the time range corresponding to the list.

In this way, depending on the moment in which the user requests the selectable beverages to be displayed, a determinate list is shown on each occasion.

According to some embodiments, the beverages present in one list are different from the beverages present in another list and/or are ordered differently in one or the other list.

Thanks to the display of a plurality of lists that are differentiated in relation to a specific time range and are correlated to his/her habits, the user has directly available the beverages that he/she favors for that determinate time range, so the desired beverage can be selected in a very simple and fast manner.

According to another aspect of the invention, the data storage module is also configured to store at least the frequency with which a determinate beverage is selected by the user in a determinate time interval, and to process the lists so as to order the beverages on the basis of the stored frequency of selection in order to highlight the most selected beverages for each time range.

Thanks to the display of a plurality of lists of most frequently selected beverages, the present coffee machine advantageously allows for a simple and intuitive use. In fact, the beverage usually desired at a determinate moment of the day can be selected more quickly than what occurs in known machines.

The time of use of the present coffee machine is therefore advantageously reduced, as well as the laboriousness of the operations to be carried out in order to choose a beverage, making the use of the machine by a user more comfortable and faster.

Moreover, thanks to the shorter time required to select the beverages, the display can be kept switched on for a shorter amount of time, possibly also allowing to achieve energy savings.

According to another aspect of the invention, the at least one list comprises a plurality of beverages in a descending order on the basis of the frequency of selection.

According to another aspect of the invention, the lists are associated with corresponding selection commands present on the display.

According to another aspect of the invention, the display comprises at least one command for enabling and disabling an automated display mode of the lists.

According to another aspect of the invention, the time ranges are stored in the data storage module, each associated with a determinate user profile and the control unit is configured to process the lists as a function of the user profile associated with a user who is recognized on each occasion by means of a user interface.

According to another aspect of the invention, the display comprises a command configured to allow the user to vary the parameters of the beverage to be prepared.

According to another aspect of the invention, a plurality of user profiles can be stored in the storage module, each comprising the beverages selected by a specific user, and possibly the parameters customized for each beverage.

The user profile can also comprise respective time ranges defined by respective start and end limits which can be customized by the user.

According to another aspect of the invention, the control unit comprises a wireless communication module configured to allow data exchange with a processor owned by the user.

A dedicated software application can be installed in the processor by means of which the user can, for example, modify the time ranges, changing their start and end limits, or delete them and insert new ones.

The invention also concerns a method for managing a coffee machine, comprising the storage of information concerning at least the beverages selected by a user by means of the user interface of the coffee machine in a determinate time interval and a time stamp correlated to the moment in which such beverages are selected, the processing of a plurality of lists of selected beverages, respectively associated with predefined time ranges as a function of the time stamp, and the display of the beverages associated with one of the lists on the display, on the basis of the time interval and the time ranges.

According to one aspect of the present invention, the management method provides to store the frequency with which a determinate beverage is selected by the user in the time interval, the processing of at least one of such lists also based on the frequency of selection, and the display, on the display of the user interface, of the lists so as to highlight the most selected beverages for each of them.

According to another aspect of the invention, the management method provides to define the time ranges associated with each of the lists on the basis of start and end limits set by a user by means of a processor configured to exchange data with the control unit.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic view of a coffee machine according to the present invention;

FIGS. 2 to 8 are views of a display provided in a user interface of the present coffee machine in various data display situations.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

With reference to the attached drawings, see in particular FIG. 1, a coffee machine 10 comprises a control unit 11 provided with a processor 12 and connected to a user interface 13 provided with at least one display 14 for displaying dispensable beverages B1, B2, B3 . . . Bn.

The control unit 11 comprises at least one data storage module 15, configured to store at least information regarding the beverages B1, B2, B3 . . . Bn which are selected by a user in a determinate time interval, for example over the course of a day, a week, or even a month.

In particular, the data storage module 15 is configured to store information comprising both the beverage selected and also a time stamp correlated to the moment in which such beverage was selected. For example, every time a beverage is selected, the time and/or day of the week, or other, can also be stored.

The detection and storage of the above information by the data storage module 15 is carried out automatically each time a user selects a beverage to be prepared.

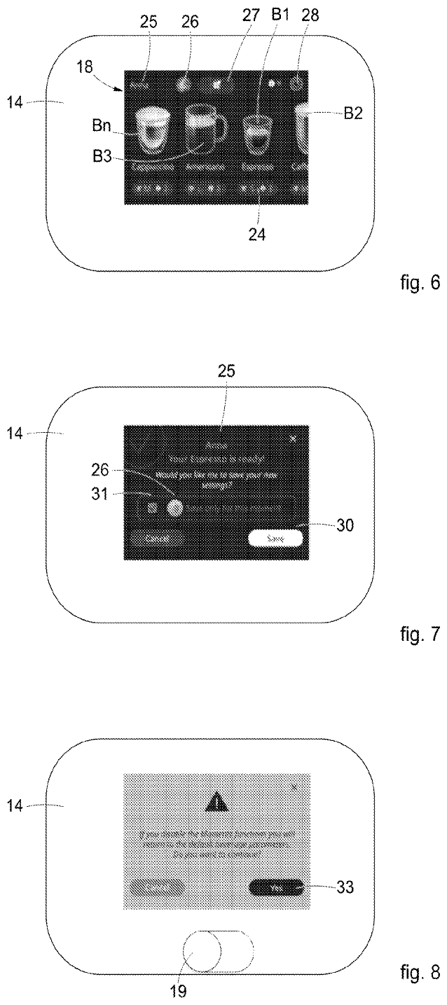

The control unit 11 is configured to process a plurality of lists 16 (FIG. 4), 17, 18 (FIGS. 5 and 6) of the selected beverages, respectively associated with predefined time ranges of the time interval considered, and to display them on the display 14 ordered differently on the basis of the time ranges.

In other words, depending on the moment, that is, the instant in time in which a display of the beverages on the display 14 is requested, the control unit 11 selects and displays on the display 14 the beverages associated with the list 16, 17, 18 corresponding to the time range to which this instant in time belongs.

On the basis of the data stored in the data storage module 15, the control unit 11 can also automatically associate the beverages with the respective time ranges and therefore update the respective lists 16, 17, 18 accordingly.

For example, one or more time ranges can be defined and the control unit 11, as a function of the information stored in the data storage module 15, can determine, for each time range, which beverages are selected and possibly also the number of times such beverages are selected.

Respective start and end instants can be stored in the storage module 15 for each time range.

According to possible embodiments, the time ranges can correspond to respective time slots into which a day can be divided, such as “morning”, “afternoon”, “evening”, or correspond to one or more days of the week, considered individually, such as “Monday”, “Tuesday” etc., or divided into groups, such as “weekdays” and “holidays”, or even be correlated to respective weeks, for example in the event a user works two or three different shifts.

According to some embodiments, these time ranges can be defined in the design phase and stored in a memory unit of the machine 10, for example in the data storage module 15, or they can be entered and/or modified by a user, for example through the user interface 13 or a processor 29, for example a smartphone, a tablet or other, on which a dedicated software application is installed.

In particular, it can be provided that a user can modify at least the start and end instants of one or more time ranges.

According to some embodiments, the data storage module 15 is configured to also store at least the frequency with which a determinate beverage B1, B2, B3 . . . Bn is selected by the user in a determinate time interval by means of the user interface 13, for example over the course of a day, or in each time slot provided, and the control unit 11 is configured to process at least one list of beverages based on said frequency of selection, see for example the list 16 of FIG. 4 or any of the other lists 17 and 18 of FIGS. 5 and 6, and then present it on the display 14 so as to highlight the most selected beverages for each time range.

In this way, not only are the beverages B1, B2, B3 . . . Bn normally selected within each time range shown for each time range, but the beverages are also ordered on the basis of the number of times they have been selected by the user.

This display mode helps to make using the machine 10 even more convenient and faster.

According to some embodiments, the time interval considered to evaluate the frequency of selection can be the entire interval which has elapsed since the first power on, or since a reset of the machine 10, or only a limited period of time can be considered, for example a few weeks or a few months. This second option allows to adjust the display in a more dynamic manner with respect to a possible change in user preferences.

The at least one list 16 comprises a plurality of beverages, see for example the beverages B1, B2, B3 . . . Bn of FIG. 4, in descending order on the basis of the frequency of selection, therefore the beverage B1 that appears at the beginning of the list 16 is the beverage most selected by the user in a determinate period of time, while the beverage Bn is the one selected with less frequency. Of course, the list 16 can comprise a higher or smaller number of beverages, based on the number of beverages that can be produced by the coffee machine 10.

According to some embodiments, the mode for displaying the beverages as a function of the defined time ranges can be activated by the user by means of a corresponding command 19, which is shown on the display 14. This command 19 can be, for example, a two-position virtual key located on a touchscreen-type display 14.

When this display mode is active, the list 16, 17, 18 to be displayed is determined automatically by the control unit, as a function of the current time.

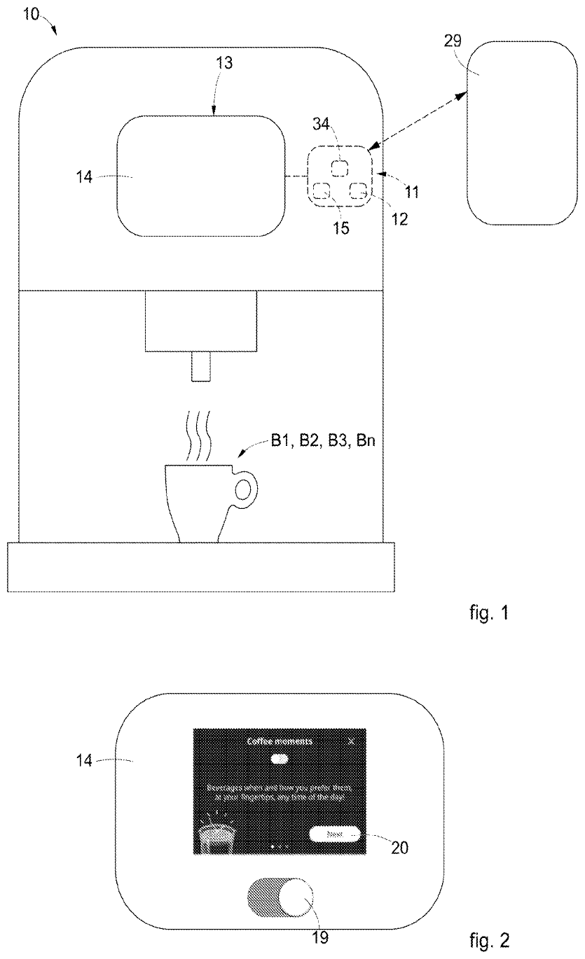

It can therefore be assumed that when switched on, the coffee machine 10 presents the screen of FIG. 2 and allows to select the beverage display function according to the lists of beverages usually selected. If the command 19 is not activated, the coffee machine 10 works in the conventional manner. Otherwise, by means of an additional command 20, it is possible to go to the next screen.

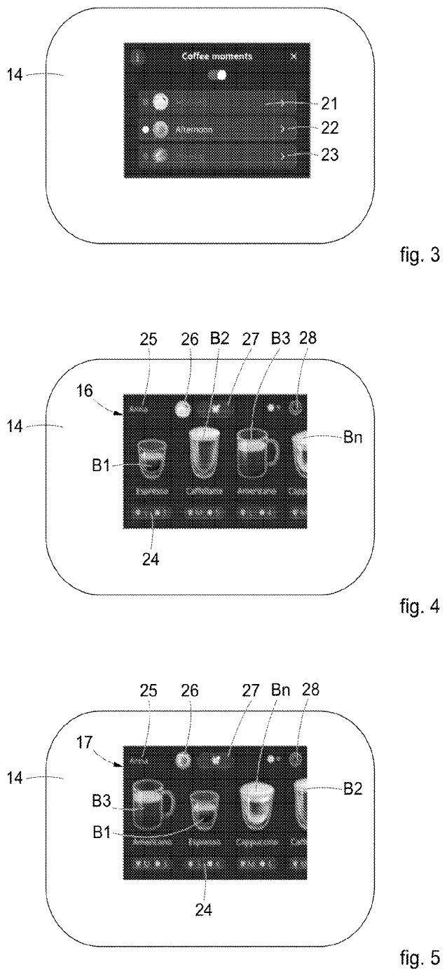

The next screen can be directly one of the lists 16, 17, 18 of FIGS. 4, 5, 6, or the screen of FIG. 3, in which a list of time ranges is shown, in particular associated with a determinate user profile, and the time range currently used is highlighted, that is, the time slot corresponding to the moment in which the display is performed.

In the case of time ranges associated with a user profile, for each of them it is possible to store, in the storage module 15, the respective start and end instants, which can be fixed for all profiles or possibly modifiable by a user, for example through the processor 29.

According to some embodiments, there can also be a plurality of different commands 21, 22, 23, in the example case three, that is, one for each time range, which allow to select the corresponding lists 16, 17, 18 of beverages in order to possibly view information correlated to them. In this way, a user can, for example, modify the start and end instants of one or more time ranges, change their name, or possibly add new ones.

Preferably, the list 16, 17 or 18 associated with a determinate time range is automatically shown on the display 14, on the basis of the current day or time of day, which can be easily evaluated by the control unit 11.

These different lists 16, 17, 18 can refer, for example, to different time slots of the day, for example the list 16 can refer to a morning time slot, the list 17 can refer to an afternoon time slot, while the list 18 can refer to an evening time slot.

For example, the morning time slot can vary from 6 to 12 a.m., the afternoon time slot can vary from 12 to 18 p.m., and the evening time slot can vary from 20to 24 p.m.

In the screen of FIG. 3, for example, the “morning” slot will be indicated as active at 10.00 a.m., while the “afternoon” slot will be active at 15 p.m.

According to some embodiments, it is possible to provide a function which allows the user, through the display 14 or the processor 29, to vary the time slots at will, to vary the number of lists over the course of a day, for example to have a single list for the whole day, or divide the day into more than three slots or other, such as, for example, vary the type of time ranges considered, on a daily, weekly, monthly basis, etc.

According to some embodiments, when the automatic display of the lists is set, a respective list 16, 17, 18 is displayed depending on the time, for example following receipt of a command to activate the display 14, or to prepare a new beverage.

In the example case, if the current time belongs to the morning time slot, the list 16 is displayed, if the current time belongs to the afternoon time slot, the list 17 is displayed and if the current time belongs to the evening time slot, the list 18 is displayed.

In addition, within each list, the order of the beverages is defined on the basis of the number of times they have previously been selected for each time range.

For example, we have assumed that in the list 16 relating to the morning time slot, the beverage most selected by the user is the beverage B1, which is therefore highlighted at the top of the list 16.

In the list 17 relating to the afternoon time slot, the beverage most selected by the user is the beverage B3, which is therefore highlighted at the top of the list 17.

In the list 18 relating to the evening time slot, the beverage most selected by the user is the beverage Bn, which is therefore highlighted at the top of the list 18.

The user, based on the time slot in which he/she wants to use the machine 10 to prepare a beverage, will obtain a list 16, 17, or 18 which has at the top the beverage B1, B2, B3 . . . Bn which he/she usually consumes in that time slot of the day, therefore he/she can quickly and easily select the beverage usually consumed, instead of scrolling through the machine's menu and setting the type and parameters of the beverage each time.

It is also possible to display some parameters for each beverage B1, B2, B3 or Bn, such as for example the quantity, which can be small, medium or large, please see the label 24, the degree of aroma of the coffee or other.

Moreover, these customized parameters can be stored in the data storage module 15 in such a way that, as a function of the respective time range considered, the beverage displayed on each occasion in the respective list 16, 17, 18 comprises its own customized parameters. In this way, an “espresso” beverage of a given time range could, for example, comprise a “strong” taste and a “large” quantity as parameters, while an “espresso” beverage of another time range could comprise a “light” taste and a “medium” quantity as parameters, and so on.

On each of the screens relating to the lists 16, 17 and 18 additional commands and labels can also be provided, for example a label 25 which indicates the name of the user, a label 26 which indicates the time slot, a command 27 for returning to a general screen, a command 28 which allows access to the settings, or others.

Each of the images of the beverages B1, B2, B3 and Bn of the various lists 16, 17, 18 is associated with a command, therefore by pressing on an image the coffee machine 10 starts to prepare the selected beverage. For example, if the beverage B1 is pressed, the coffee machine 10 starts to prepare it and its parameters, for example quantity, aroma or other, will automatically be the last ones set.

The user has the possibility of changing the parameters of a determinate beverage before its preparation, for example by pressing the command 28 and by means of another screen of the display 14, not shown. When the selected beverage is ready, a screen appears on the display 14, FIG. 7, which allows, through a command 30, to save the current settings for the list which the selected and ready beverage is part of. If the user decides to save the settings by ticking the box 31 and pressing the command 32, the list 16, that is, the list associated with the current time range, is updated and saved. Alternatively, it is possible to leave the beverage parameters as present in the last saved list.

The coffee machine 10 can naturally operate without this mode for displaying one or more favorite and habitually used lists 16, 17, 18 by deselecting this function through a suitable command 33 of a screen which can be accessed, for example, through the settings command 28, see for example FIG. 8.

In this case, the beverages B1, B2, B3, Bn are dispensed with the coffee machine's 10 default parameters, possibly modifiable on each occasion, and no preference lists are presented for the selection of the beverages.

According to possible embodiments, it can be provided that, in the event that the display function with time slots is disabled, on the display 14 the selectable beverages B1, B2, B3, Bn are in any case displayed according to the frequency with which they are selected, ordered in a customized manner on the basis of a defined user profile, or on the basis of the overall selections made by all users.

According to some embodiments, the control unit 11 can also comprise a wireless communication module 34 configured to allow data exchange, even remotely, with the processor 29 owned by the user.

By means of an application installed on the processor 29 it is possible to remotely access the display and time ranges setting function, as a function of which the control unit 11 can subsequently define the one or more lists 16, 17, 18.

For example, it is possible to provide a function which allows the processor 29 to set and vary the start and end of the predefined time ranges, for example the start and end times of the time slots that can be displayed.

Another function that can be implemented in the application installed on the processor 29 is that of varying the name of the various time ranges, or varying the time ranges as a function of the days of the week, for example the working day time ranges can be different from the time ranges of public holidays, or other.

Another function that can be implemented in the application installed on the processor 29 can be for example the possibility of remotely varying the parameters of the various beverages B1, B2, B3, Bn, therefore their quantity or others.

If there is more than one user of the coffee machine 10, through the application installed on the processor 29 it is also possible to select a user's own profile or one of the profiles that use the machine 10, and then view the preferences of a determinate profile on the display 14, therefore ultimately the one or more lists 16, 17, 18.

The selected beverages B1, B2, B3 . . . Bn can be stored, for example, in a specific user profile associated with a specific user. The user profile can for example be made available following its selection on the user interface 13, or following a recognition of the user himself, for example through the scanning of a code with an optical reader or suchlike, or by means of wireless communication between the processor 29 and the control unit 11.

A method for managing the coffee machine 10 therefore comprises the storage of information concerning at least the beverages selected by a user by means of the user interface 13 in a determinate time interval and a time stamp correlated to the moment in which such beverages are selected, the processing of a plurality of lists of selected beverages, respectively associated with predefined time ranges as a function of the time stamp, and the display of the beverages in the lists 16, 17, 18 on the display 14, ordered in a differentiated manner on the basis of the current time range.

According to one aspect of the present invention, the management method provides to store at least the frequency with which a determinate beverage is selected by a user in a determinate time interval, that is, in each time range, by means of the user interface 13, the processing of at least one list of beverages based on the frequency of selection, for example one of the lists 16, 17 or 18, and the display of the at least one list on the display 14 so as to highlight the most selected beverages for each time range.

It is clear that modifications and/or additions of parts may be made to the coffee machine 10 and to the corresponding management method as described heretofore, without departing from the field and scope of the present invention, as defined by the claims.

It is also clear that, although the present invention has been described with reference to some specific examples, a person of skill in the art shall certainly be able to achieve many other equivalent forms of coffee machine 10 and corresponding management method, having the characteristics as set forth in the claims and hence all coming within the field of protection defined thereby.

In the following claims, the sole purpose of the references in brackets is to facilitate their reading and they must not be considered as restrictive factors with regard to the field of protection defined by the same claims.

1. A coffee machine (10), comprising; a control unit (11) provided with a processor (12) and connected to a user interface (13) provided with at least one display (14) for displaying dispensable beverages (B1, B2, B3 . . . Bn), wherein said control unit (11) comprises at least one data storage module (15) configured to automatically store information regarding at least the beverages (B1, B2, B3 . . . Bn) selected by a user by means of said user interface (13) in a determinate time interval and a time stamp correlated to the moment in which such beverages (B1, B2, B3 . . . Bn) are selected, and said control unit (11) is configured to process a plurality of lists (16, 17, 18) of said selected beverages (B1, B2, B3 . . . Bn), respectively associated with predefined time ranges as a function of said time stamp, and to display the beverages (B1, B2, B3 . . . Bn) associated with one of said lists (16, 17, 18) on said display (14) on the basis of the time range corresponding to said one of said list (16, 17, 18).

2. The coffee machine (10) as in claim 1, wherein said data storage module (15) is configured to store at least the frequency with which a determinate beverage is selected by the user in said time ranges, and to process said lists (16, 17, 18) to order the beverages on the basis of the stored frequency of selection in order to highlight the most selected beverages in each time range.

3. The coffee machine as in claim 1, wherein at least one of said lists (16, 17, 18) comprises said beverages (B1, B2, B3 . . . Bn) ordered in descending order on the basis of the frequency of selection.

4. The coffee machine (10) as in claim 1, wherein the beverages (B1, B2, B3, . . . , Bn) present in one list (16, 17, 18) are different from the beverages (B1, B2, B3, . . . , Bn) present in another list (16, 17, 18) and/or are ordered differently in one or the other list (16, 17, 18).

5. The coffee machine (10) as in claim 1, wherein said user interface (13) comprises at least one command (19) for enabling and disabling an automated display mode of said lists (16, 17, 18) on said display (14).

6. The coffee machine (10) as in claim 1, wherein said lists (16, 17, 18) are associated with corresponding selection commands present on said display (14).

7. The coffee machine (10) as in claim 1, wherein respective start and end instants of said time ranges are stored in said data storage module (15), each one associated with a determinate user profile, and said control unit (11) is configured to process said lists (16, 17, 18) and to display them on said display (14) as a function of the user profile associated with a user recognized on each occasion by means of said user interface (13).

8. The coffee machine (10) as in claim 1, wherein said user interface (13) comprises a command (28) configured to allow the user to vary parameters of the beverage to be prepared, and in that said beverage (B1, B2, B3 . . . Bn) profiles are stored in said data storage module (15) with parameters that are customized as a function of said time ranges.

9. The coffee machine (10) as in claim 1, wherein said control unit (11) comprises a wireless communication module (34) configured to allow data exchange with a processor (29).

10. The coffee machine (10) as in claim 1, wherein said control unit (11) comprises a wireless communication module configured to allow data exchange with a user's processor (29) by means of which said user is able to modify said time ranges, changing their start and end limits, or cancel them and enter new ones.

11. A method for managing a coffee machine (10), comprising storing information regarding at least the beverages selected by a user through a user interface (13) in a determinate time interval and a time stamp correlated to the moment in which such beverages are selected, processing of a plurality of lists (16, 17, 18) of selected beverages, respectively associated with predefined time ranges as a function of said time stamp, and displaying the beverages (B1, B2, B3 . . . Bn) associated with one of said lists (16, 17, 18) on said display (14) on the basis of said time range corresponding to said list (16, 17, 18).

12. A method for managing a coffee machine (10) as in claim 11, comprising storing a frequency with which a determinate beverage is selected by said user in said time ranges, processing of at least one of said lists (16, 17, 18) also based on said frequency of selection, and displaying, on the display (14) of the user interface (13), of said at least one list (16, 17, 18) so as to highlight the most selected beverages in each time range.

13. A method for managing a coffee machine (10) as in claim 11, wherein said time ranges are respectively associated each one with a determinate user profile, and the processing and displaying of said lists (16, 17, 18) occurs as a function of the user profile associated with a user recognized on each occasion by through said user interface (13).

14. A method for managing a coffee machine (10) as in claim 11, comprising defining the time ranges associated with each of said lists (16, 17, 18) on the basis of start and end limits set by a user through a processor (29) configured to exchange data with a control unit (11) in wireless mode.

15. A method for managing a coffee machine (10) as in claim 11, comprising setting a mode for displaying the beverages as a function of said time ranges defined as a function of an activation signal received from a user through a corresponding command (19).
